(19) United States
(12) Patent Application Publication
(10) Pub. No.: US 2026/0350729 A1
(43) Pub. Date: Nov. 5, 2026

(54) STRUCTURED INTENT PATENT APPLICATION DRAFTING WITH GENERATIVE RESPONSE ENGINE

(71) Applicant: Simon BOOTH, San Rafael, CA (US)

(72) Inventor: Simon BOOTH, San Rafael, CA (US)

(21) Appl. No.: 19/661,175

(22) Filed: Apr. 28, 2026

Related U.S. Application Data
(60) Provisional application No. 63/800,258, filed on May 5, 2025.

(51) Int. Cl. G06Q 50/18; G06F 3/04842; G06F 3/0486; G06F 40/103; G06F 40/143; G06F 40/166

(52) U.S. Cl. CPC G06Q 50/184; G06F 40/103; G06F 40/143; G06F 40/166; G06F 3/04842; G06F 3/0486

(57) ABSTRACT

Disclosed are systems, apparatuses, processes, and computer-readable media for generating patent applications. For example, an apparatus is configured to display a user interface including a tree interface, wherein the tree interface is configured to display first tree data associated with a section of a patent application; receive a first input in the user interface that configures a first node of the first tree data; send a first prompt to the generative response engine, wherein the first prompt includes a writing policy, the first tree data in a data interchange format, and a natural language explanation of each node type associated with the first tree data; and obtain a response from the generative response engine, the response including first generated content that corresponds to the first tree data and conforms to the writing policy.

### TECHNICAL FIELD

The present invention relates to generative response engines. More particularly, the invention relates to patent application drafting using structured intent.

### BACKGROUND

Conventional patent application drafting techniques focus on thoroughly describing an invention to meet the legal requirements for patentability, including novelty, inventive step, and industrial applicability. Practitioners typically begin with a clear and concise title, followed by a detailed background section outlining existing problems and prior art. The specification then provides a comprehensive description of the invention, including preferred embodiments, supported by drawings if necessary. Claims are carefully crafted to define the legal scope of protection, with broad independent claims and narrower dependent claims to cover various aspects and embodiments. Drafters prioritize clarity, precision, and consistency throughout the document, ensuring that the disclosure enables a person skilled in the art to reproduce the invention while anticipating potential objections from patent examiners.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods, computer readable medium, and circuits for performing a function. According to at least one example, a method is provided for generating patent application content. The method includes: displaying a user interface including a tree interface, wherein the tree interface is configured to display first tree data associated with a section of a patent application; receiving a first input in the user interface that configures a first node of the first tree data, wherein the first tree data encodes a writing intent associated with the section prior to invoking a generative response engine; sending a first prompt to the generative response engine, wherein the first prompt includes a writing policy, the first tree data in a data interchange format, and a natural language explanation of each node type associated with the first tree data; and obtaining a response from the generative response engine, the response including first generated content that corresponds to the first tree data and conforms to the writing policy.

In another example, an apparatus for generating patent application content is provided that includes a storage (e.g., a memory configured to store data, such as virtual content data, one or more images, etc.) and at least one processor (e.g., implemented in circuitry) coupled to the memory and configured to execute instructions and, in conjunction with various components (e.g., a network interface, a display, an output device, etc.), cause the apparatus to: display a user interface including a tree interface, wherein the tree interface is configured to display first tree data associated with a section of a patent application; receive a first input in the user interface that configures a first node of the first tree data, wherein the first tree data encodes a writing intent associated with the section prior to invoking a generative response engine; send a first prompt to the generative response engine, wherein the first prompt includes a writing policy, the first tree data in a data interchange format, and a natural language explanation of each node type associated with the first tree data; and obtain a response from the generative response engine, the response including first generated content that corresponds to the first tree data and conforms to the writing policy.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

Illustrative embodiments of the present application are described in detail below with reference to the following drawing figures:

FIG. 1 illustrates an example block diagram of a patent application drafting system;

FIG. 2 illustrates an example process for patent application drafting using a patent application drafting system similar to FIG. 1;

FIG. 3 illustrates an example block diagram of a structured intent patent application drafting system in accordance with some aspects of the disclosure;

FIG. 4 illustrates an example visual representation of a structured intent patent application drafting UI in accordance with some aspects of the disclosure;

FIG. 5 illustrates an example process for a document container in accordance with some aspects of the disclosure;

FIG. 6 illustrates an example visual representation of an image in accordance with some aspects of the disclosure;

FIG. 7 illustrates an example process for generating patent application using a structured intent patent application drafting system in accordance with some aspects of the disclosure;

FIG. 8 illustrates an example process for generating patent application using a structured intent patent application drafting system in accordance with some aspects of the disclosure; and

FIG. 9 is a diagram illustrating an example of a system for implementing certain aspects of the present technology.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Conventional document drafting environments, including word processing applications used for preparing technical and legal materials, generally present document content and editing controls in a manner that requires substantial manual coordination by a user. A user may compose body text in a primary document pane, generate graphical content such as drawings or diagrams in another application, and separately operate menus, comments, or auxiliary tools to update the surrounding narrative. There is no relationship between the image and the associated explanatory text is maintained in a separate surface, and the addition of large language models (LLMs) adds another surface to coordinate the drafting of the patent application and its different requirements. While LLMs can generate sufficient text, keeping that text aligned becomes a bigger burden as the volume of text content increases.

Commercial systems are attempting to improve this problem, by collocating drawing features with text generation features, have created yet another surface because downstream users (e.g., inventors, inhouse counsel) still use a conventional word processor to review the patent application. Moreover, existing commercial systems can increase when drafting workflows because it's a different work surface that is constantly evolving by adding new features, which increases friction these systems are intended to solve.

Agentic systems are not sufficient for patent application drafting because the various commercial patent-writing workflow are centered on a single, specialized surface in which the application is assembled, organized, and edited across many generic tools or interfaces. Agentic systems may generally be understood as systems that combine multiple user-interface surfaces, data sources, and generation modalities to perform broader-purpose functions. However, when agentic systems are used to build highly specific content such as patent applications, excessive variation or deviation can present substantial risk. Patent drafting benefits from explicit structure, scoped generation, preserved relationships, and constrained editing so that claims, figures, transcript content, and descriptions remain consistent and unambiguous. In this way, overly autonomous generation for patent applications may create deviations that are difficult to detect because patent content is highly interdependent across figures, claims, labels, and descriptions, and errors may not be obvious if structure and scope are not tightly controlled. Fully autonomous systems for patent drafting creates significant malpractice and validity risks that can affect every aspect of a patent's lifecycle.

Systems, apparatuses, processes (also referred to as methods), and computer-readable media (collectively referred to as “systems and techniques”) are described herein for generating patent applications using a user interface that includes a tree interface and a generative response engine. For example, a system is configured to display first tree data associated with a section of a patent application, receive an input that configures a first node of the first tree data to encode a writing intent associated with the section prior to invocation of the generative response engine, send a first prompt to the generative response engine that includes a writing policy, the first tree data in a data interchange format, and a natural language explanation of each node type associated with the first tree data, and obtain a response including first generated content corresponding to the first tree data and conforming to the writing policy.

In some aspects, the systems and techniques are configured to generate prompts for use in drafting a section of a patent application based on a hierarchical configuration. For example, a global configuration object may define writing policy parameters such as tone, terminology, and formalism requirements applicable across multiple sections of the patent application, while a document configuration object associated with the patent application may include a claim set and a technical description of the patent application. A section configuration object associated with a particular section may include tree data encoding a writing intent for the section, a figure kind identifier selecting a figure kind profile, and one or more image features identifying labeled elements to be described in generated content for the section. The system may resolve an effective configuration for the section by merging the global configuration object, the document configuration object, and the section configuration object according to a precedence hierarchy in which section-level parameters take precedence over document-level parameters and document-level parameters take precedence over global-level parameters.

In some aspects, the tree interface enables structured interaction with claims, generated responses, and image-derived inputs in connection with drafting the patent application. For example, claims associated with the patent application may be displayed with limitations separated by line breaks, a selection of a limitation may be received, and user input of the selection into a node of the tree interface may be detected. In some implementations, a chat interface for the generative response engine may be displayed, the chat interface including at least one response associated with another prompt to the generative response engine, and a selection associated with the response may be received and inserted into a parent node of the tree interface, such as by a drag operation or a drag associated with a node type. In further examples, an input image associated with the section may be received, an image description of the input image may be obtained in at least two formats including a structured format and an unstructured format, and the first prompt may include the image description. In some cases, insertion of an image inline with text of the section may be detected, a prompt including the image and a portion of the writing policy may be transmitted to the generative response engine, and an initial set of nodes organized as initial tree data may be obtained based on components and relationships identified in the image.

In some aspects, the response from the generative response engine may itself be structured for continued use by the system in generating and updating the patent application. For example, the response may be formatted in the data interchange format and include second tree data, a text description generated based on the first tree data and the writing policy, and a patch of nodes used to update the first tree data and the user interface. In some implementations, generation of the first prompt may include ordering nodes of the first tree data based on a depth-first traversal prior to serialization into the data interchange format and/or sorting nodes based on an order of parent nodes. In further aspects, the first prompt may further include a schema defining the node types of the first tree data, and the generated text description may be inserted into a document at a location identified by an interpolation tag carrying an instruction specifying content to be generated at that location.

In some aspects, the systems and techniques further support persistence and document generation operations associated with the patent drafting workflow. For example, the first tree data and a portion of the writing policy may be stored as a data artifact within a custom XML constituent of an electronic document file so that the writing intent persists locally within the electronic document file without requiring an external data store. The patent application may then be generated as an electronic document including at least the generated text content. In this way, the systems and techniques enable structured authoring intent, configuration data, image-derived information, and generated prose to be coordinated within a unified patent application drafting workflow.

The systems described herein integrate any recited computational concepts into a practical application that improves the computer-implemented process of generating patent applications using generative response engines. The systems and techniques described herein provide a specific, bounded improvement to the computer process of content generation by requiring that writing intent be encoded in a structured hierarchical tree data structure prior to invocation of a generative response engine, and by using that tree data, together with a resolved writing policy and a natural language explanation of each typed node, to constrain and direct the generation operation. This approach demonstrably reduces reliance on iterative post-generation correction cycles, decreases token consumption associated with repeated context retransmission, and produces specification content that is more reliably scoped to claim limitations and document structure than content produced through open-ended prompting. Nothing in this specification should be construed as being performed by a person, and no limitation is intended to require human mental activity. Each recited step is performed by a computing device, an add-in application, or a generative response engine, and the claimed combination of structured pre-generation intent encoding, policy-constrained prompt assembly, and typed node schema yields a technical result that is not achievable by mental steps or generic computer instructions alone.

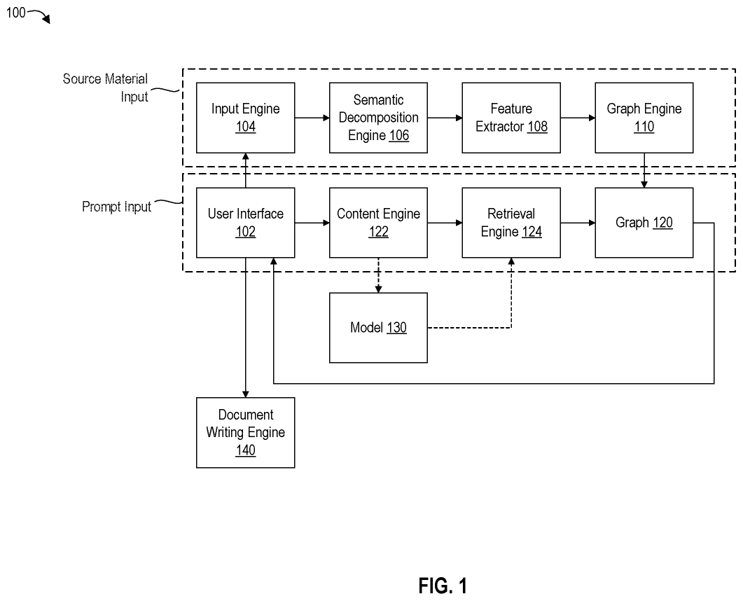

FIG. 1 illustrates an example block diagram of a patent application drafting system 100. The patent application drafting system 100 operates as an end-to-end platform that receives disclosure-related inputs and transforms them into patent application content. The system 100 comprises a user interface 102, an input engine 104, a semantic decomposition engine 106, a feature extractor 108, a graph engine 110, a graph 120, a content engine 122, a retrieval engine 124, a model 130, and a document writing engine 140. Source material inputs, including disclosures, optional prior-art materials, and other supporting content, are received by the input engine 104. In some aspects, the input engine 104 is configured to receive documents in heterogeneous formats, including portable document format files, word processing documents, and structured data files, and to normalize those inputs for downstream processing. Prompt inputs are received by the user interface 102, which is operably connected to the input engine 104, the content engine 122, and the document writing engine 140.

The semantic decomposition engine 106 is coupled to the input engine 104 and is configured to separate received source material into discrete features, structural elements, and inter-element relationships that are usable by downstream generation components. In some aspects, the semantic decomposition engine 106 applies natural language processing or other analytical techniques to identify conceptual boundaries within the source material, producing a decomposed representation that preserves the technical scope of the original input. The feature extractor 108 is coupled to the semantic decomposition engine 106 and is configured to identify technical components, operations, and inter-component relationships from the decomposed source material. The feature extractor 108 provides extracted feature data to the graph engine 110, which is configured to organize extracted concepts into a concept graph 120 or other structured representation that preserves associations among features. The graph 120 stores the resulting structured representation and serves as a shared knowledge resource for the content engine 122 and the retrieval engine 124.

The retrieval engine 124 is configured to apply retrieval-augmented generation techniques to obtain supporting information from one or more distinct retrieval sources using the graph 120. In some aspects, the retrieval sources include prior patent documents, drafting templates, and jurisdiction-specific procedural rules (not shown). In some cases, prior patent documents may inform the content engine 122 about technical conventions, thereby reducing the risk that generated content duplicates prior art or departs from established terminology. Drafting templates provide structural scaffolding for sections such as the abstract, background, summary, and detailed description, enabling the content engine 122 to organize generated text in a format consistent with examination expectations. Jurisdiction-specific rules supply constraints on claim format, disclosure sufficiency, and language conventions that vary across patent offices, and the retrieval engine 124 may apply re-indexing or re-scoring heuristics to prioritize retrieved content according to relevance to the current generation task.

The content engine 122 is coupled to the retrieval engine 124 and to the model 130, and is configured to generate one or more application artifacts, including specification text, patent claims, and summaries, from the structured representation maintained in the graph 120 and the context retrieved by the retrieval engine 124. In some aspects, content generation may proceed in an iterative, section-specific manner, in which the content engine 122 generates a portion of the application corresponding to a selected outline section, incorporates available claim language as a scope constraint, and refines output based on subsequent user direction. The model 130 (e.g., an LLM or a generative response engine) is coupled to the content engine 122 and is configured to produce natural language text responsive to generation prompts assembled by the content engine 122. The model 130 may also interface with the retrieval engine 124 in a feedback path, in which model outputs inform subsequent retrieval queries to improve contextual grounding of generated text. User-driven edits communicated through the user interface 102 may update the structured drafting data maintained in the graph 120 and trigger revised generation output from the content engine 122. The user interface 102 supports iterative refinement of generated content through prompt loops, guided editing interactions, or a combination of both.

The document writing engine 140 is coupled to the user interface 102 and is configured to assemble generated application content into a final electronic document, such as a word processing file suitable for filing or attorney review. The document writing engine 140 receives structured text, claims, abstract content, and drawing descriptions from upstream components and formats that content into a coherent application document. In some aspects, the document writing engine 140 may apply section-specific formatting rules, insert reference numeral tables, or apply style normalization prior to producing the output file. The document writing engine 140 is also coupled back to the user interface 102, enabling the user to review and further refine the assembled document before finalization.

Despite the functional coverage of the patent application drafting system 100, the user interface 102 presents significant practical challenges. Patent drafting user interfaces are frequently developed by software engineering teams that lack direct familiarity with the substantive legal and technical demands of patent prosecution. As a result, interface designs may reflect general-purpose document editing conventions rather than the structured, concept-driven workflows that patent attorneys and agents require. The user interface 102 in such systems tends to be feature-dense, presenting a broad array of options and controls that increase cognitive load and introduce friction into the drafting process rather than reducing it. Because the interface is not purpose-built around the practitioner's workflow, each generation task may require the user to navigate through menus, configuration panels, and preference dialogs that are largely irrelevant to the immediate drafting objective. Furthermore, as patent professionals are drawn into product development roles to provide domain guidance, the user interface 102 undergoes continuous revision in response to practitioner feedback, creating an interface that remains in flux and that may require retraining as workflows are reorganized across software releases.

A further challenge in the patent application drafting system 100 relates to the granularity of control available to the user during content generation. Existing systems may provide coarse generation controls that produce entire sections or claim sets in a single operation, without enabling the user to specify the ordering, emphasis, or relational structure of individual technical concepts within the output. Patent specification writing should be introduced and elaborated in a disciplined sequence to provide a clear narrative, with each element receiving antecedent basis before it is referenced in a dependent or subsequent context. When the granularity of control is insufficient to enforce this ordering, the generated output may present concepts out of sequence, omit necessary antecedent introductions, or introduce structural inconsistencies that require substantial manual correction. The remediation of such issues may consume more time than would have been required to draft the relevant sections without automated assistance, negating a primary benefit of the system 100.

A related technical limitation of the patent application drafting system 100 arises from the confident output behavior of the model 130. Generative language models are statistically inclined to produce fluent, well-formed prose regardless of whether the underlying factual or technical basis for each assertion is adequately supported by the source material provided through the input engine 104 and the graph 120. In the context of patent drafting, this behavior creates a verification burden that falls entirely on the reviewer. Each generated paragraph should be read with close attention to identify assertions that exceed the scope of the disclosure, introduce unsupported technical details, or characterize claimed subject matter in terms that may affect claim scope during examination or litigation. This attentive review requirement is non-trivial in practice, because the fluency of model-generated text can obscure substantive departures from the technical record, requiring the reviewer to cross-reference generated content against source materials in parallel rather than relying on the text as a self-consistent narrative. Generative response engines may also use terms that may look innocuous that the reviewer does not fully comprehend, creating a risk that the subject matter is technically incorrect.

The overreliance on automated generation in the patent application drafting system 100 also introduces legal risk in two specific contexts. First, with respect to professional liability, a patent practitioner who submits application content to a patent office retains full responsibility for the accuracy, completeness, and legal sufficiency of that content, regardless of the automated tools used in its preparation. Content generated by the model 130 that misstates claim scope, omits material technical features, or incorporates language inconsistent with the disclosure may constitute a deficiency in the prosecution record that gives rise to malpractice exposure if the resulting patent is subsequently challenged or found unenforceable. Because the system 100 does not provide a mechanism for automatically verifying that generated content remains within the bounds of the source material and the claim set, the practitioner must independently perform that verification, and the degree to which that obligation is met may be difficult to document. Second, with respect to depositions and adversarial proceedings, generated specification language may be scrutinized to establish what a person of ordinary skill in the art would understand the scope of the claims. Statements in the specification produced by the model 130 that go beyond what the inventors disclosed, or that characterize technical operations with a specificity not supported by the record, may be used to narrow or broaden claim interpretation in ways that were not intended and that the practitioner did not anticipate at the time of filing. The patent application drafting system 100 does not provide structural safeguards against this category of risk, and the resulting exposure is borne by both the practitioner and the applicant.

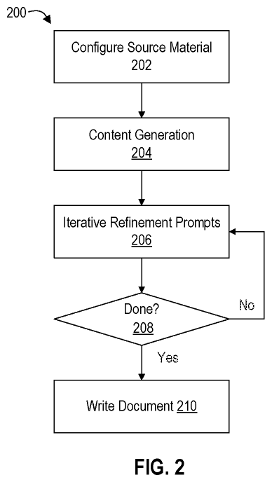

FIG. 2 illustrates an example process 200 for patent application drafting using a patent application drafting system similar to FIG. 1.

At block 202, the patent application drafting system 100 may configure source material by preparing and normalizing input materials used for downstream generation. In some aspects, configuring source material may include receiving disclosures, prior art references, technical papers, or supplemental specification notes through the input engine 104, and organizing that content into a structured representation accessible to the content engine 122. The configuration operation may further include applying the semantic decomposition engine 106 and the feature extractor 108 to decompose received materials into discrete features and inter-element relationships that inform subsequent generation. In some aspects, the source material configuration at block 202 may be optional, such that the patent application drafting system 100 may proceed to content generation based on prompt input alone, without requiring uploaded source materials.

At block 204, the patent application drafting system 100 may perform content generation by producing draft document content based on the configured source material and applicable prompting logic. In some aspects, the content engine 122 assembles one or more generation prompts incorporating retrieved context from the retrieval engine 124, structured feature data from the graph 120, and any applicable writing policy constraints, and then transmits those prompts to the model 130 to obtain generated text. Content generation at block 204 may produce one or more application artifacts, including specification sections, patent claims, an abstract, or a summary of the disclosure, depending on the generation scope established by the user through the user interface 102. In some aspects, content generation may be section-specific, such that the patent application drafting system 100 generates a targeted portion of the application corresponding to a selected outline node or claim limitation rather than producing the entire document in a single operation.

At block 206, the patent application drafting system 100 may apply iterative refinement prompts to revise, expand, or correct generated content produced at block 204. In some aspects, refinement prompts may be directed at a specific section, a particular claim element, or a passage identified by the user as requiring modification, and the model 130 may generate revised text responsive to those prompts within the context established by preceding generation cycles. The iterative refinement prompts at block 206 may address a range of correction objectives, including correction of technical inaccuracies, resolution of antecedent basis deficiencies, adjustment of claim scope language, or expansion of enabling detail for a specific component or operation.

At block 208, the patent application drafting system 100 may evaluate whether the generated content satisfies one or more completion criteria established by the user. In some aspects, the completion criteria may include assessments of technical accuracy, claim coverage, section completeness, or consistency of terminology across the document. If the user determines at block 208 that the generated content does not satisfy the applicable completion criteria, process 200 returns to block 206 for one or more additional refinement cycles. This return path represents a recurring operational pattern in the patent application drafting system 100, and it carries several compounding costs. Each refinement cycle requires the user to locate the deficient passage through the user interface 102, formulate a targeted correction prompt, and re-evaluate the revised output against both the specific correction objective and the broader document context. Because the model 130 does not maintain state between generation calls, the full conversation or document context may be retransmitted with each refinement request, resulting in substantial token consumption that increases proportionally with document length and the number of prior refinement cycles. The return loop at block 208 may also introduce term drift across successive refinement cycles, in which the model 130 applies terminology in revised passages that diverges from conventions established in earlier generated sections, creating cross-section inconsistencies that require further correction and extend the total number of refinement iterations. The cumulative effect of these dynamics is that the iterative refinement loop, rather than converging efficiently toward a finalized document, may itself become a primary source of friction in the drafting workflow, constraining the practical effectiveness of the patent application drafting system 100.

At block 210, after the user determines at block 208 that the completion criteria are satisfied, the patent application drafting system 100 may write the finalized document by outputting an assembled electronic document incorporating the generated and refined application content. In some aspects, the document writing engine 140 receives the approved content from the content engine 122 and formats that content into a complete application document, applying section-level structure, reference numeral conventions, and any applicable style normalization prior to producing the output file. The output artifact produced at block 210 may be a word processing document, a structured markup file, or another electronic format suitable for attorney review or patent office submission. This output artifact then traverses the drafting workflows through internal review, external review by inventors and inhouse counsel, and other processes that live outside of the context of the patent application drafting system 100.

The iterative refinement loop between blocks 206 and 208 concentrates and amplifies each of the systemic limitations of the patent application drafting system 100 described above. Each return to block 206 reintroduces the interface friction of the user interface 102, requires the user to re-scope a correction prompt against the structured content of the graph 120, and retransmits accumulated context to the model 130, consuming tokens in proportion to the total document length and revision history. In applications involving lengthy specifications or numerous claim dependencies, this token consumption may become a practical constraint on the depth of refinement achievable within a single drafting session. The confident output behavior of the model 130 persists across each refinement cycle, meaning that each revised passage requires the same attentive cross-referencing against source materials that the initial output demanded, multiplying the verification burden rather than reducing it. The cumulative effect is that the loop between blocks 206 and 208 does not merely reflect the limitations of the patent application drafting system 100 but actively compounds them, converting what the system 100 presents as a correction mechanism into a recurring source of the same inefficiency, risk, and practitioner burden that the system was intended to address.

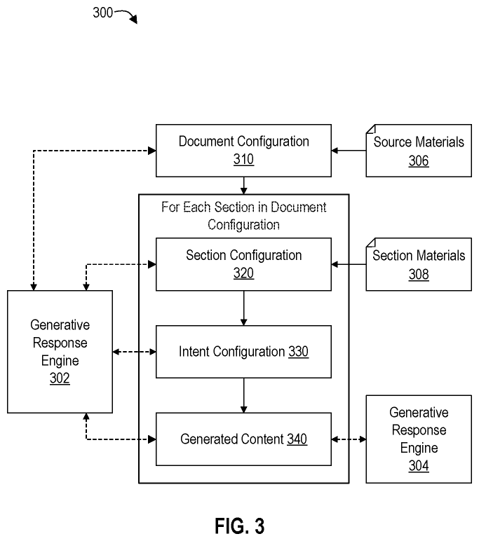

FIG. 3 illustrates an example block diagram of a structured intent patent application drafting system 300 in accordance with some aspects of the disclosure. In some aspects, the structured intent patent application drafting system 300 is configured to scope content generation to specific section using writing intent with a writing policy that configures the generative response engine to generate text like a patent attorney. Rather than allowing iterative prompts, the structured intent patent application drafting system 300 is more deterministic and provides flexibility in what to describe using a hierarchy.

The structured intent patent application drafting system 300 comprises a generative response engine 302, a generative response engine 304, a document configuration 310, source materials 306, a section configuration 320, section materials 308, an intent configuration 330, and generated content 340. The system 300 organizes the drafting workflow into two primary input configurations, a document configuration 310 that establishes application-level parameters and a section configuration 320 that governs the generation of individual application sections. Solid arrows within the system 300 denote primary data or control flow between components, while dashed connections denote generative-assistance, feedback, or iterative interactions involving the generative response engine 302 or the generative response engine 304.

In some aspects, a generative response engine comprises any system, machine learning model, or service configured to receive a prompt and produce a response based on that prompt, including large language models, multimodal models, retrieval-augmented generation systems, and other machine learning based text or structured data generation systems. The generative response engine accessed locally, via an application programming interface, or through a cloud-based inference service and may include additional auxiliary services, such as agentic harnesses, coding platforms, and so forth. In some cases, the generative response engine may be a collocated server that is configured to inference using open source models.

The document configuration 310 is coupled to receive source materials 306 and is configured to establish the application-level parameters that govern downstream section generation. In some aspects, the document configuration 310 encodes jurisdiction-specific or technology-domain-specific requirements that vary materially across application types, such as the structural and claim conventions applicable to circuit-based applications relative to the enablement and written description standards applicable to chemical or biological subject matter. The document configuration 310 may carry type-specific writing policy that shapes how subsequently generated content is scoped, organized, and expressed throughout the document. The source materials 306 may include disclosure documents, inventor disclosure transcripts, prior non-provisional applications, technical papers, or supplemental specification notes, and the document configuration 310 is coupled to receive those materials as inputs that inform the application-level configuration. In some aspects, the generative response engine 302 may be applied to semantically segment received source materials 306, generate feature embeddings, or chunk semantic content into structured representations usable by downstream components, enabling the document configuration 310 to ground its parameters in the technical content of the received materials rather than relying solely on user-specified settings.

The section configuration 320 is coupled to the document configuration 310 and to section materials 308, and is configured to establish the generation parameters applicable to an individual section of the patent application. The section materials 308 may include receiving a figure associated with the section, an image of the corresponding figure, or other section-specific inputs, and the section configuration 320 is configured to parse those inputs into at least two distinct formats. Non-limiting examples include a Mermaid-parseable structured representation, a natural language text description, and a JSON-based structural description. The different formats may enable downstream components to access section content in the format best suited to the applicable generation task. In some cases, the image may be omitted as a known format can be provided (e.g., Mermaid). The section configuration 320 may also receive section-level metadata such as a a section title, a diagram type (e.g., flowchart, block diagram, image, conceptual diagram, etc.) or a section type identifier that associates the section with a recognized structural category. In some aspects, the section configuration 320 further includes configuring a writing policy applicable to the section, and one technique for establishing that policy is by selecting a diagram type associated with the section, such as a flowchart, block diagram, or sequence diagram, which causes the system 300 to apply the corresponding figure-kind profile to the generation of that section. Writing policy configuration may also be applied to non-figure sections, such as a technical problem statement or technical solution summary, by selecting a content type that maps to a corresponding set of generation constraints.

The intent configuration 330 is coupled to the section configuration 320 and configured to receive inputs that collectively encode the writing intent for the associated section. For example, the intent configuration 330 may comprise a hierarchical tree of typed nodes that supports four primary node types that each carry a distinct semantic role within the tree. An instruction node encodes pure writing intent, specifying what conceptual content to generate for a given scope within the tree, and may include markdown-formatted content to convey fine-grained directives such as ordered topics, emphasis signals, or examples of permissible elaborations. A section node functions as a non-emitting grouping node that defines organizational scope within the tree and communicates structural context to the generative response engine 302 without itself contributing generated text. A constraint node modifies the applicable writing policy for its subtree, enabling localized overrides such as permission to generate a list, produce a code example, or restrict terminology to a specified vocabulary. A claim segment node carries a portion of a claim recitation supplied through a user interface and instructs the generative components to produce content that supports the corresponding claim limitation, anchoring the generated text to the claim scope without requiring the model to reproduce claim language verbatim. Other types of nodes are possible, and the described nodes are provides an illustrative examples.

The intent configuration 330 provides several structural advantages over prompt-based generation approaches. The hierarchical organization of the tree establishes an authoritative ordering of concepts, enabling both macro-level control over section structure through parent nodes and micro-level control over individual elaborations through child nodes, so that the sequence in which technical concepts are introduced and developed in the generated output reflects the practitioner's deliberate organizational intent rather than the model's statistical tendencies. The typed node schema makes the tree deterministic in its interpretation: each node kind carries a defined behavioral contract that governs how the generative response engine 302 processes it, reducing ambiguity in how writing directives are applied and producing generation outputs that are more consistent across successive invocations. The tree structure is also simple to construct and modify, as practitioners may add, reorder, or retype nodes to adjust writing intent at any granularity without reformulating an entire prompt or reconstructing the generation context from scratch.

The generated content 340 is produced for each section configuration 320 by either the generative response engine 302 or the generative response engine 304, and the system 300 is configured to support both engines to provide flexibility in model selection and vendor choice. The generative response engine 302 is operably connected to the document configuration 310, the section configuration 320, the intent configuration 330, and the generated content 340, and operates in two distinct modes depending on the generation task. In a context-based conversational mode, the generative response engine 302 is configured for exploratory interaction, with permission to retrieve content from available retrieval-augmented generation resources and to surface outside context into its responses, supporting tasks such as brainstorming, claim analysis, or structured inquiry into source materials. In a non-context-based writing mode, the generative response engine 302 is configured to generate the content 340 for a designated section based on the structured prompt assembled from the intent configuration 330 and the applicable writing policy, with retrieval-augmented generation access permitted but strictly scoped to prevent source material content from leaking into specification prose in ways that would introduce unsupported subject matter or displace the practitioner's authorial voice. The generative response engine 304 is operably connected to the generated content 340 may operate without context sharing and without retrieval-augmented generation access with a writing policy that scopes generated text to the provided materials. In some aspects, the generative response engine 304 may produce higher-quality generation output for certain section types or with certain model configurations, and the system 300 may therefore route generation tasks to the generative response engine 304 when the absence of contextual carry-over and the precision of a targeted structured prompt are together sufficient to produce the output.

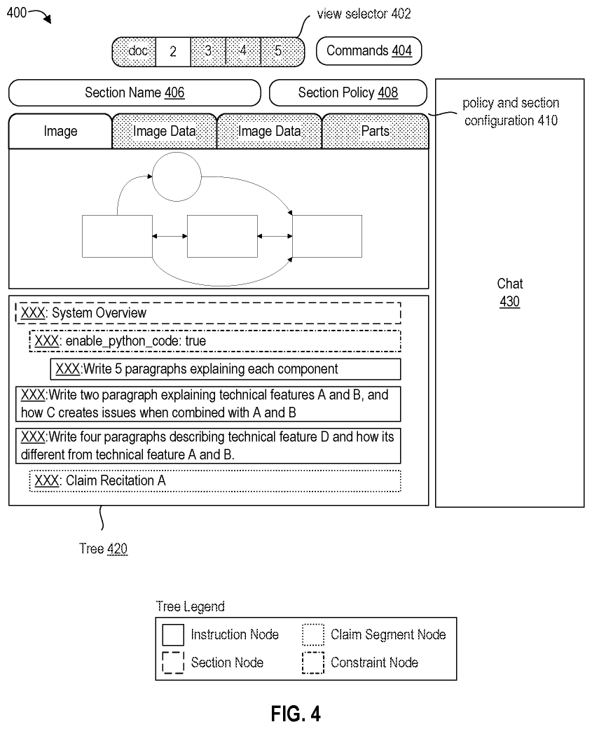

FIG. 4 illustrates an example visual representation of a structured intent patent application drafting UI 400 in accordance with some aspects of the disclosure.

The structured intent patent application drafting UI 400 provides a workspace for configuring section content, writing policies, and drafting interactions associated with a selected section of a patent application. The UI 400 organizes its controls and panels into distinct interface regions, including a view selector 402, commands 404, a section name 406, a section policy 408, a policy and section configuration 410, a tree 420, and a chat 430. The UI 400 is configured to support a practitioner-driven drafting workflow in which writing intent is encoded structurally before generation is invoked, enabling the practitioner to exercise both application-level and section-level control from a single interface.

The view selector 402 is positioned within a top bar region of the UI 400 and comprises a segmented control that supports navigation among document-level or figure-level views within the drafting session. In some aspects, each segment of the view selector 402 corresponds to a distinct section or figure of the application under preparation, enabling the practitioner to navigate between sections without leaving the authoring context. The commands 404 are positioned within the top bar region proximate to the view selector 402 and comprise interface controls for invoking authoring or editing operations applicable to the current view, such as saving the current state, initiating content generation, and other functions such as clearing intent, closing the session, etc.

The section name 406 is positioned within a configuration header row of the UI 400 and comprises a text input control for identifying the currently selected drafting section. In some aspects, the section name 406 corresponds to the label of the section or figure being authored, such that the name entered in the section name 406 is reflected in the structured drafting data associated with the current section. For example, for a section corresponding to the UI 400, the section name 406 may carry a value such as “structured intent patent application drafting UI 400,” establishing the identity of the section within the document configuration.

The section policy 408 is positioned within the configuration header row adjacent to the section name 406 and is configured to receive policy or instruction data associated with the selected section. In some aspects, the section policy 408 comprises a drop-down control or similar selection mechanism that allows the practitioner to designate a section type, such as a block diagram, flowchart, or sequence diagram figure type, which causes the UI 400 to apply the corresponding writing policy profile to downstream generation operations for that section. The section policy 408 may further support selection among policy variants associated with a given section type, including tenant-specific or client-specific bespoke policies that reflect the conventions of a particular technology domain, prosecution practice, or organizational style guide. Other types of input may be used to further scope the writing policy, such as specific variants and features (e.g., standard essential patents, target product, and so forth). This extensibility allows the UI 400 to accommodate the divergent drafting conventions applicable across different application types and different practitioner organizations without requiring modification of the underlying generation components.

The section configuration 410 occupies the main workspace of the UI 400 as a composite left panel that aggregates image-related inputs, extracted structural data, component parts, and drafting controls for the currently selected section. The section configuration 410 includes sub-tabs for accessing an image view, image data, and a parts listing, enabling the practitioner to inspect and configure the section's source inputs alongside the structured drafting controls. A preview area within the section configuration 410 displays a visual representation of the figure associated with the section, providing spatial context for the elements being described. The tree 420 is positioned within the section configuration 410 and comprises a hierarchical arrangement of typed nodes that collectively define the writing intent for the section.

In some aspects, the tree 420 supports visually distinct node types that are differentiated by line style and are identified in a legend displayed in a lower region of the UI 400. An instruction node carries a natural language directive specifying what conceptual content to generate for a given scope within the tree 420, and may contain fine-grained guidance such as a paragraph count, a list of features to address, or a comparative framing between technical elements. A section node functions as a non-emitting grouping node that provides organizational scope to its descendants without itself producing generated text. A constraint node modifies the applicable writing policy for its subtree, enabling localized overrides such as enabling code generation or restricting terminology. A claim segment node carries a portion of a claim recitation and instructs the generation component to produce supporting content aligned to that claim limitation.

The tree 420 defines the writing intent for the section in a form that provides both macro-level and micro-level control over the structure and content of generated output. At the macro level, parent section nodes and high-level instruction nodes establish the organizational scope of major content blocks, determining the sequence in which technical concepts are introduced across the section. At the micro level, child instruction nodes within a given scope may carry highly specific directives, such as a precise paragraph count, a named set of technical features to compare, or a description of how one element creates interaction effects with others, enabling the practitioner to govern individual passages of the generated text with a degree of precision that is not achievable through open-ended prompt formulation. The generative response engine is specifically instructed to follow the hierarchical ordering of the tree 420 during generation, so that the sequence of nodes in the tree is faithfully reflected in the sequence of concepts in the generated output. This property allows the practitioner to control what is written and the order in which it is written, which is a property of material importance in patent specification drafting where antecedent basis and logical concept ordering carry legal and technical consequence.

In some aspects, the tree 420 may include model-generated nodes in addition to practitioner-authored nodes. A suggested node (not shown) represents a recommendation produced by the generative response engine identifying content that the practitioner may wish to address within the current section. Suggested nodes may be generated in two ways. In a first mode, the practitioner may request suggested content for an empty tree 420, in which case the generative response engine returns a structured set of nodes organized as a tree reflecting a proposed coverage plan for the section. These suggested nodes may be reviewed, edited, reordered, and promoted within the tree 420 using the same interaction mechanisms available for practitioner-authored nodes, including the ability to modify the type of node. In a second mode, the practitioner may request suggested content scoped to a specific existing node, in which case the generative response engine returns a patch of nodes for that node's subtree, each identifying a feature, relationship, or elaboration that the practitioner may wish to incorporate. Suggested nodes of both types support a conversational authoring dynamic in which the generative response engine contributes structured drafting recommendations that the practitioner can selectively accept, modify, or discard, enabling iterative construction of a complete and well-organized writing intent without requiring the practitioner to formulate the full tree from scratch.

The chat 430 is positioned within a right panel of the UI 400 and supports user-system drafting interaction contextual to the selected section and tree configuration. The chat 430 may be configured with a writing policy that differs from the section-level policy applied to the tree 420, enabling the practitioner to use the chat 430 for exploratory or investigative interactions, such as querying source materials, evaluating claim scope language, or requesting alternative technical framings, without those interactions affecting the policy constraints governing formal section generation. In some aspects, the UI 400 is configured to allow the practitioner to select content from a response in the chat 430 and incorporate that content into the tree 420 directly, providing a fluid path from conversational exploration to structured writing intent. The tree 420 is designed to support intuitive manipulation, including drag-based reordering, node type reassignment, and hierarchical reorganization, so that the practitioner can refine writing intent efficiently as the drafting session progresses.

In some aspects, the structured intent patent application drafting UI 400 includes a claims panel that displays the claims associated with the patent application under preparation. The claims panel renders each claim with its limitations separated by their natural line breaks, presenting each limitation as a discrete selectable unit without requiring a model-driven segmentation or phrase-typing step. The practitioner may open the claims panel, review the claim limitations in their natural form, and drag a selected limitation directly into the tree 420 of the currently active section, where it is deposited as a claim segment node at the position and hierarchical level determined by the drop target within the tree 420. The claim segment node thereby anchors a portion of the writing intent for that section to a specific claim limitation, and the generative response engine 302 encounters that node during generation and produces supporting specification content scoped to that limitation without reciting the claim language verbatim.

Any node deposited in the tree 420 is fully editable after placement, and the node can be edited to include markdown to provide emphasis and other flags the generative response engine can use in generating text. In some aspects, the practitioner may modify the text of the claim segment node directly within the tree 420, for example to paraphrase a limitation, narrow the scope of the writing instruction, add clarifying context, or combine language from multiple limitations into a single node. This editability allows the claim segment node to function both as a direct reference to filed claim language and as a practitioner-directed writing instruction that may diverge from the original limitation text as the drafting session evolves. Because the claim segment node is a typed node within the tree 420, the generative response engine 302 interprets it in accordance with the claim segment node semantics defined in the writing policy, regardless of whether its text reflects verbatim claim language or a practitioner-modified adaptation. In some aspects, a claim segment node (or any node) may be repositioned within the tree 420 after placement, allowing the practitioner to adjust the hierarchical relationship between the claim limitation and surrounding instruction nodes or constraint nodes as the section structure is refined.

In some aspects, the prompt transmitted to the generative response engine for a given section is constructed through a hierarchical inheritance model comprising a global configuration, a document configuration (e.g., the document configuration 310) and a section configuration (e.g., the section configuration 320). The global configuration defines global standards such as document writing target (e.g., a patent application), merge policies, schemas, writing policies, and validation policies. The global configuration can be static, but may also be modified by, for example, excluding features not relevant (e.g., a schema associated with a figure).

The document configuration provides document-level data, such as title, claims, a technical problem, a summary, vector store information, stored file data. The section configuration inherits the document configuration as a baseline and applies section-specific refinements, including the figure kind profile (e.g., the type of figure such as flowchart, etc.), the subject of the section (e.g., the section name), and any localized policy overrides scoped to that section alone. When a conflict exists between a document configuration parameter and a section configuration parameter, the document configuration takes precedence, ensuring that application-level constraints are not inadvertently overridden by section-level settings. This precedence relationship makes prompt construction deterministic, in that the effective policy applied to any given generation operation is fully resolved before the prompt is transmitted to the generative response engine, rather than being left to the model to arbitrate from ambiguous or conflicting inputs. Generative response engines write better when where is less ambiguity or conflict, and the prompt policy aligns the generative response engine to focus efforts on writing policy and intent, providing consistent results.

Table 1 below illustrates an example JSON object that is provided to a generative response enginel. For example, the JSON may be serialized (e.g., via JSON.stringify(object_name)) and provided to a model with a corresponding basic prompt that links execution to the serialized JSON.

TABLE 1

```
{
  “global_config”: {
    “meta”: {...},
    “merge_policy”: {...},
    “schemas”: {
      ...
      “node_kinds”: {
        “section”:
          “emits_output”: false,
          “description”: “Non-emitting section-scoping node that
defines the objective and drafting intent for its subtree.”
          },
        “instruction”: {
          “emits_output”: false,
          “description”: “Non-emitting directive describing what
content to generate.
        },
        “constraint”:{
          “emits_output”: false,
          “description”: “Non-emitting local rule or requirement
that narrows/clarifies output. Must refine (not negate) higher -
level policy.”
        },
        “claimSegment”:{
          “emits_output”: false,
          “description”: “Non-emitting semantic anchor
representing a claim-derived limitation. Used to keep drafting
aligned with claim scope; not emitted verbatim.”
        },
        “suggestion”:{
          “emits_output”: false,
          “description”: “Non-emitting assistant note that flags
issues or opportunities (e.g., ambiguity, definition drift,
over-claiming risk, missing enabling detail).”
        },
      ...
    },
    “writing_policies”: {...},
    “validation_stage”: {...},
  },
  “document_config”: {
    “title”: “”,
    “claims”: [...],
    “technical_problem”: “”,
    “technical_solution”: “”,
    “validation_stage”: {...},
  },
  “section_config”: {
    “writing_instruction”: “”,
    “tree”:[...],
    “kind”: [...],
    “fig_number”: 1,
    “image_data_primay”: “”,
    “image_data_alt”:“”,
    “image_features”: [...]
    “profile”: {...}
  }
}
```

The data structure in table 1 comprises three nested configuration objects organized in a precedence hierarchy. The global configuration object carries application-wide parameters that apply across all documents and all sections, including the merge policy that governs how conflicts between configuration levels are resolved, the node kind schema that defines the behavioral contract and natural language description of each node type, the writing policies that establish tone, terminology, formalism requirements, and coverage expectations, and a validation stage that specifies checks applied to generated output before it is accepted. The document configuration object carries parameters specific to the patent application under preparation, including the title, the claim set, a technical problem statement, and a technical solution summary, and may include its own validation stage that applies document-level constraints beyond those defined globally. The section configuration object carries the parameters specific to the individual section being generated, including a writing instruction that provides figure-level narrative guidance. The tree comprises the serialized intent configuration in array form, the figure kind identifier that selects the applicable figure kind profile (e.g., used to further modify the JSON in table 1), the figure number, primary and alternative image data representations of the figure associated with the section, the image features listing the labeled elements that the generated prose should cover, and a profile object that aggregates the resolved effective policy for that section after the merge policy has been applied across all three configuration levels. When the prompt is assembled, the generative response engine 302 receives the fully merged configuration as a single structured artifact in which the global writing policy, the document-level claim context, and the section-level writing intent are all present and resolved, enabling the model to generate content that is simultaneously consistent with application-wide conventions, grounded in the claim set, and scoped precisely to the intent encoded in the tree 420 of the current section. In some aspects, the level of detail corresponding to a prompt in table 1 has a complexity that precludes human level modification because, while manual editing of JSON is feasible, the time needed to configure the JSON manually would exceed any time savings.

In some aspects, the intent configuration includes the tree 420 ordered based on a depth-first principle and serialized, together with a schema that defines the structure and semantics of the node types present in the tree. The schema serves two distinct purposes within the prompt. First, it provides a natural language description of each node kind, explaining the purpose, behavioral contract, and generation implications of each type, for example describing an instruction node as a directive specifying what content to generate, a constraint node as a local policy modification applicable to its subtree, and a claim segment node as a semantic anchor derived from a claim limitation that the generated content should support. These natural language descriptions guide the generative response engine in interpreting the instruction within the tree 420 during generation without requiring the model to infer node semantics from structure alone. Second, the schema defines the structural contract for any nodes the generative response engine may return as output, constraining the shape, fields, and permissible values of returned node objects so that they can be programmatically merged into the tree 420 by the structured intent patent application drafting UI 400 without additional parsing or validation overhead.

The output format of the generative response engine may be configured as either structured output or text output depending on the nature of the generation task. When the structured intent patent application drafting UI 400 uses the generative response engine to return nodes, for example when generating suggested nodes, expanding an existing node, or producing an initial tree in response to a new section, structured output is used and the response is constrained by the node schema so that the returned content conforms to the tree 420 data model and can be merged directly into the existing tree without manual reformatting. When the structured intent patent application drafting UI 400 requests prose for the specification, text output is used and the tree 420 is consumed as input context that governs the structure, scope, and writing intent of the generated text rather than as a template for the output format. In some aspects, the output format selection may be determined automatically based on the task type associated with the generation request, such that node-returning tasks should invoke structured output and prose-generating tasks should invoke text output, reducing the configuration burden on the practitioner. In some cases, the text can also be structured in an object to pass data into the application, but configured to stream the resulting text (e.g., using newline delimited JSON) without requiring a parser.

In some aspects, the generative response engine may automatically generate an initial tree 420 in response to an image being added to the structured intent patent application drafting UI 400. For example, when an image is introduced into a section by pasting a figure into document (e.g., document 610), the structured intent patent application drafting UI 400 may transmit a prompt to the generative response engine that includes the image, the applicable writing policy inherited from the document configuration, and the node schema. The generative response engine analyzes the image and returns a structured output comprising an initial set of tree nodes organized as a tree 420 that reflects the components, relationships, and conceptual groupings visible in the image. In some aspects, this automatic tree generation may identify labeled elements in the image, propose instruction nodes corresponding to each major component or subsystem, and suggest claim segment nodes where visible features correspond to limitations in the claim set carried by the document configuration. The practitioner may then review, edit, reorder, and supplement the generated tree 420 before invoking prose generation, using the automatically generated tree as a starting point rather than constructing the writing intent from an empty tree. In some aspects, this capability can be related to a linked image (e.g., linked image 612 below) interaction described below, in which the detection of an image insertion event in the document (e.g., document 610 below) triggers the addin (e.g., addin 620 below) to initiate a corresponding section configuration and, in some aspects, to invoke the automatic tree generation operation for that image.

In some aspects, each node can also include grounding features that link the retrieval augmented engines to the instructions (e.g., in an instruction node). For example, a hash tag (e.g., #) may deterministically be used inline in markdown to indicate the presence of grounding features, allowing the user to select a document or features within a document (e.g., semantically segmented features of a document that are surfaced to the user). For example, the document level configuration generates key-value pairs that link a key (e.g., a document name such as disclosure, transcript, etc.) to a value of that document (e.g., an identifier generated by the retrieval engine that identifies the document for programmatic access). In other cases, the grounding can also simply use the key name inline with text. In this case, using specific names that have casing features (e.g., camel case, pascal case, kebab case, etc.) such as disclosure_forms can improve retrieval accuracy.

The structured intent patent application drafting system represents a structural inversion of the generation workflow relative to the patent application drafting system described in FIG. 1. In the patent application drafting system 100, writing intent is communicated to the model through open-ended prompts, and the quality and scope of the generated output is controlled through the iterative refinement loop (e.g., as shown in FIG. 2), in which deficiencies in the generated content are identified after the fact and addressed through successive correction cycles. The structured intent patent application drafting system inverts this relationship by requiring the practitioner to encode a complete, hierarchically ordered, policy-constrained specification of writing intent into the tree 420 before any generation is invoked. The generative response engine receives a fully resolved prompt in which the organizational structure of the content, the granularity of each elaboration, the claim limitations to be supported, the terminology constraints to be observed, and the output format to be produced are all determined prior to generation rather than negotiated through post-generation correction. Because the writing intent is specified upstream of the generation step rather than inferred from it, the structured intent patent application drafting system reduces dependence on the iterative refinement loop as a quality control mechanism, reduces the token consumption associated with repeated context retransmission, and reduces the attentive verification burden that arises when the model operates without bounded scope. The tree 420 thereby functions as an organizational aid and as the primary instrument through which the practitioner exercises authorial control over the generated specification.

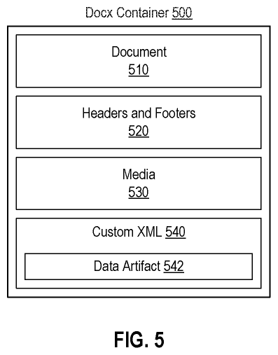

FIG. 5 illustrates an example process for a document container 500 in accordance with some aspects of the disclosure.

The document container 500 (or any structured office document such as a word file (.docx) presentation files (.pptx), drawing files (.vsdx), spreadsheet files (e.g., .xlsx), etc.) is a ZIP-based archive format that organizes the content of a word processing document across a set of discrete XML constituent documents, each encapsulating a distinct functional aspect of the overall file. The document 510 is the primary XML constituent and carries the main body text, paragraph structure, run-level formatting, and embedded drawing references that constitute the visible content of the application. The headers and footers 520 comprise a separate XML constituent that defines the repeating content rendered in the top and bottom margins of each page, and the media 530 comprises a separate binary resource store that contains embedded image files, figures, and other non-text assets referenced by drawing elements within the document 510. Additional XML constituents within the document container 500 define specialized features such as list numbering schemes, hyperlink relationships, comments, and footnotes, each maintained in isolation from the others to support modular access and targeted editing. The custom XML 540 is a further separate XML constituent that may be included within the document container 500 to store arbitrary structured data alongside the document content, independent of the presentation layer represented by the document 510, the headers and footers 520, and the media 530. The data artifact 542 is a structured data payload stored within the custom XML 540 and represents an authoritative state container that persists application-specific structured information directly within the document container 500 without requiring an external data store.

A patent drafting workflow that operates as a standalone web application introduces a context-switching cost that may degrade practitioner efficiency through a mechanism consistent with cognitive load effects under dual process theory. When a practitioner navigates between a web-based drafting interface and the word processing document that serves as the ultimate output artifact, the transition between work surfaces requires the practitioner to reconstruct working context in the destination surface, including the current section scope, the relevant claim elements, and the state of the structured drafting data, before productive work can resume. This context reconstruction imposes a system-2 cognitive burden under dual process theory that is distinct from the drafting task itself and that compounds over the course of a drafting session involving multiple figures and sections. The friction introduced by maintaining two separate work surfaces is not merely a usability inconvenience but a substantive productivity cost, as each transition creates an opportunity for context loss, missed cross-references, or inconsistencies between the structured drafting state maintained in the web application and the document content that the practitioner is simultaneously reviewing and editing.

An alternative structural configuration of the structured intent patent application drafting system places the drafting interface within the same work surface as the output document, eliminating the context-switching cost associated with a separate web application. In some aspects, the structured intent patent application drafting system may be configured as a Microsoft Word add-in or a comparable word processor extension, embedding the user interface controls, the tree, the chat, and the section configuration directly within the document editing environment. This co-location allows the practitioner to author writing intent, invoke generation, and review generated output without leaving the document context. One structural difference applicable to a word processor add-in configuration is that the claims contained within the document 510 itself may serve as the authoritative source of claim text, rather than a separately maintained claim data structure, because the claims are directly accessible and editable within the same work surface and any revision to claim language is immediately reflected in the document the practitioner is reading.

The custom XML 540 within the document container 500 supports a configuration in which the data artifact 542 stores the authoritative structured state of the drafting session locally within the document container 500 itself. In some aspects, the data artifact 542 may carry the document configuration, the section configurations, the intent configurations, and any generated content associated with each section, such that the complete drafting state travels with the document file and remains accessible without network connectivity or an external database. This local state persistence contrasts with web application configurations of the structured intent patent application drafting system, in which the structured drafting state may reside in an external database or remote data store that is scoped to a user account or session rather than to the document file itself. In a web application configuration, the association between a given document and its structured drafting state depends on an external linkage that may be disrupted by file copying, renaming, or transfer to another user, whereas a data artifact 542 embedded in the custom XML 540 maintains that association intrinsically within the document container 500 regardless of how the file is distributed or stored. This allows reviewers direct access to the work surface used in drafting the application, allowing an improved and streamlined process. In some aspects, the custom XML can be removed with a function in an application. When filing an application with custom XML, various patent offices may remove custom XML. Custom XML is also not persisted when converted to PDF files.

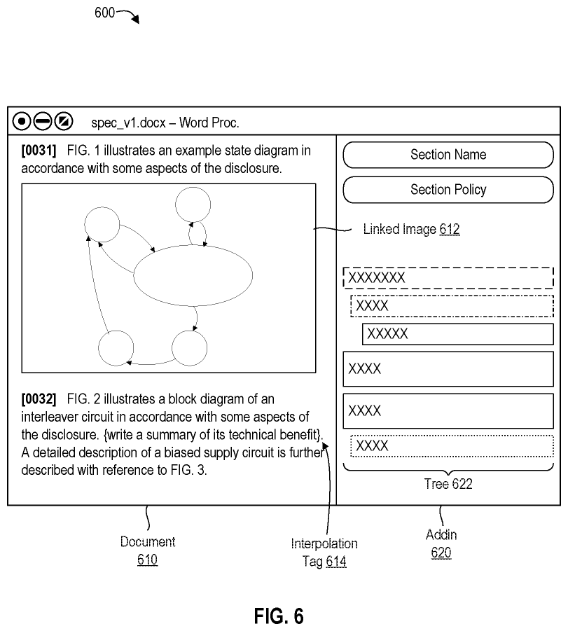

FIG. 6 illustrates an example visual representation of an image 600 mapped to a structured intent patent application drafting system inside a word processing application environment in accordance with some aspects of the disclosure.

The image 600 depicts a word processing application environment comprising a document 610 displayed in a left pane and an addin 620 rendered in a right task pane adjacent to the document 610. The document 610 occupies the primary editing region of the application window and presents body text alongside embedded graphical content, and the addin 620 provides structured drafting controls that operate alongside the document 610 within the same application surface. The co-location of the document 610 and the addin 620 within a single application window reflects the word processor add-in configuration of the structured intent patent application drafting system described above, in which the drafting interface and the output document share a unified work surface.

The document 610 comprises body text organized into numbered paragraph regions and includes at least one embedded drawing positioned within the body content. The body text regions include paragraph markers identifying passages associated with figure descriptions, and the embedded drawing within the document 610 comprises a visual representation of a corresponding figure of the application under preparation. The document 610 thereby interleaves textual specification content with graphical figure content within the same editable body, distinguishing the role of prose paragraphs from the role of inserted drawing objects.

The addin 620 is positioned within the right task pane of the application window, adjacent to and synchronized with the document 610. The addin 620 comprises drafting controls including a section name field, a section policy control, a linked image 612 reference, and a tree 622. In some aspects, the addin 620 is configured to remain synchronized with content selected or active within the document 610, such that the controls and structured data displayed within the addin 620 correspond to the section of the document 610 currently in focus.

The linked image 612 is a reference within the addin 620 that is operably connected to the embedded drawing within the document 610. In some aspects, when an image is pasted or inserted into the document 610, the addin 620 is configured to detect that insertion event and automatically generate a corresponding section configuration within the structured intent patent application drafting system, initiating a drafting context for the inserted figure. The document 610 maintains an internal relationship between the body content and the media constituent of the document container 500, and that relationship may be extracted by the addin 620 to identify the linked image 612 and to support automatic operations such as analyzing the image to generate image data for use in the section configuration. For example, the images in the document 610 include at least a relationship identifier that maps to the corresponding document in the document container, and the addin 620 can extract these relationships to determine various features (e.g., the/612 is selected, an so forth). The tree 622 is contained within the addin 620 and comprises a hierarchical arrangement of typed nodes displayed as stacked rows, with dashed rows corresponding to non-emitting node types such as section or constraint nodes and solid rows corresponding to instruction nodes that carry writing directives. In some aspects, the addin 620 uses the structured drafting techniques of the structured intent patent application drafting system to generate text based on the tree 622 and then inserts that generated text directly into the document 610 without requiring the practitioner to copy content between separate application surfaces.

Inline insertion of generated content into an existing paragraph of the document 610 presents a localized challenge even within the add-in configuration. Extracting a specific passage from the document 610, revising that passage through a chat or generation interaction, and then replacing the original passage with the revised version requires the system to identify the precise insertion scope, apply the revision, and reconcile the result with surrounding content, a set of operations that introduces friction whether the drafting interface is a web application or an embedded add-in. The interpolation tag 614 addresses this challenge by marking a specific insertion location within the body text of the document 610 as a structured placeholder. The interpolation tag 614 carries an instruction specifying the content to be generated at that location, enabling the addin 620 to process the tag deterministically and produce targeted generated text that is scoped to the marked position. In some aspects, the interpolation tag 614 is replaced by generated content delivered as tracked changes within the document 610, allowing the practitioner to review the exact textual modifications proposed by the generation operation before accepting them, using the native revision review workflow of the word processing application. Interpolation tags 614 may also be used to define the entire content of a paragraph when a paragraph body consists solely of an interpolation tag 614, in which case the generation operation produces the complete paragraph text at that location rather than modifying surrounding content. The document 610 may contain multiple figure type placeholders within the same body, including state diagrams and block diagrams embedded at different paragraph positions, and the interpolation tag 614 mechanism may be applied independently at each such location to support section-specific generation without disturbing the rest of the document.

In some aspects, the addin 620 may be configured to read comments applied to the document 610 and to generate prompts based on those comments that update corresponding generated content. In this configuration, a practitioner may annotate a passage of the document 610 with a comment describing a desired revision, and the addin 620 may process that comment, formulate a targeted generation prompt, and produce revised content delivered as tracked changes using a diff of the original text. In another example, comments may be inserted by a reviewing attorney, and the addin 620 may control replacing the paragraph in track changes to facilitate the modifications requested by the reviewing attorney (on inhouse counsel). One technique for implementing this comment-driven revision workflow involves converting the relevant portion of the document 610 body into an intermediate representation of the underlying OpenXML, applying the generation-driven modification at the intermediate representation level, and then mapping the result back into tracked change markup within the document 610. This approach preserves the practitioner's ability to accept or reject each proposed change individually while enabling the addin 620 to automate the revision workflow from comment annotation through content update without requiring manual reformulation of a generation prompt.

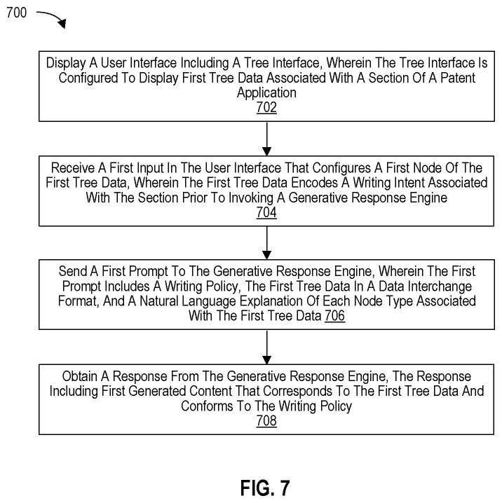

FIG. 7 illustrates an example flowchart 700 of a process for generating patent application using a structured intent patent application drafting system in accordance with some aspects of the disclosure.

At block 702, the computing device may display a user interface including a tree interface. The tree interface is configured to display first tree data associated with a section of a patent application. In some aspects, the section may correspond to a figure of the patent application, such as a block diagram, flowchart, sequence diagram, or other structural representation of a technical concept to be disclosed. The tree interface presents the first tree data as a hierarchical arrangement of typed nodes that collectively encode the writing intent for the section, and the user interface may additionally display one or more companion panels, such as a claims panel, a chat panel, and a section configuration panel, that support construction and refinement of the first tree data prior to invoking a generative response engine.

At block 704, the computing device may receive a first input in the user interface that configures a first node of the first tree data For example, the first tree data encodes a writing intent associated with the section prior to invoking the generative response engine. In some aspects, the first input may be received through several distinct interaction pathways. In one aspect, the computing device may display claims associated with the patent application, with each claim being rendered with its limitations separated by natural line breaks, and the computing device may receive a selection of a limitation of the claims and detect a user input of that selection into a node of the tree interface. In some aspects, the user input comprises a drag of the selected limitation into a target position within the tree interface, depositing the limitation as a claim segment node at the hierarchical level determined by the drop target. In another aspect, the computing device may display a chat interface for the generative response engine, the chat interface including at least one response associated with a prior prompt to the generative response engine, and the computing device may receive a selection associated with that response and detect a user input of the selection into a parent node of the tree interface. In some aspects, the user input into the tree interface comprises a drag of the selected content or a drag associated with a node type drawn from a node type menu, enabling the practitioner to deposit both content and structural scaffolding into the tree interface through a unified drag-based interaction model.

At block 706, the computing device may send a first prompt to the generative response engine. The first prompt includes a writing policy, the first tree data in a data interchange format, and a natural language explanation of each node type associated with the first tree data. In some aspects, the writing policy included in the first prompt is derived from a hierarchical configuration comprising a global configuration object defining application-wide parameters and a document configuration object defining parameters specific to the patent application. The document configuration object inherits parameters from the global configuration object and section-level parameters take precedence over document-level parameters upon conflict. Prior to serialization of the first tree data into the data interchange format, the computing device may order the nodes of the first tree data based on a depth-first traversal of the first tree data, such that ancestor nodes appear before their descendants in the serialized representation and the generative response engine processes inherited context before encountering the child directives that refine it. In some aspects, the nodes may additionally be sorted based on an order of parent nodes to further enforce the intended hierarchical reading order within the serialized prompt. The first prompt may further include a schema defining the node types of the first tree data, which serves both as a structural contract governing any nodes the generative response engine may return and as a natural language semantic guide that instructs the generative response engine how to interpret each node kind during generation.

At block 708, the computing device may obtain a response from the generative response engine, the response including first generated content that corresponds to the first tree data and conforms to the writing policy. The response may take one of two distinct forms depending on the task type associated with the generation request. In a first variant, the response is formatted in the data interchange format and includes second tree data comprising a patch of nodes, and the computing device may update the first tree data to incorporate the patch of nodes from the response and update the user interface to display the resulting second tree data. This variant is used when the generative response engine is being asked to suggest, expand, or augment the tree structure itself, such as when generating an initial set of nodes for a new section or proposing additional coverage for an existing node. In a second variant, the response includes a text description generated based on the first tree data and the writing policy, comprising specification prose suitable for incorporation into the patent application. In some aspects, the computing device may assemble the text description into an electronic document constituting the patent application, and that document may include at least the text content generated across one or more sections of the application.

In some aspects, the computing device may operate in a word processor add-in configuration in which the user interface is embedded within a word processing application rather than in a standalone web application. In this configuration, the computing device may detect insertion of an image to be inline with text of the section of the patent application, transmit a prompt to the generative response engine comprising the image and a portion of the writing policy, and obtain from the generative response engine an initial set of nodes organized as initial tree data corresponding to the section The initial set of nodes is based on components and relationships identified in the image. The computing device may further store the first tree data and a portion of the writing policy as a data artifact within a custom XML constituent of an electronic document file and the data artifact persists the writing intent locally within the electronic document file without requiring an external data store. In some aspects, the computing device may insert generated text content into the document at a location identified by an interpolation tag within the document, wherein the interpolation tag carries an instruction specifying the content to be generated at that location, enabling targeted inline generation scoped to the marked position without disturbing surrounding document content.

Table 2 below illustrates a portion writing intent (e.g., tree data) for generating the description corresponding to FIG. 7. After generation of the text, a total modification of 11 words (insertions and deletions) to above description of FIG. 7 were made arrive at the provided description corresponding to FIG. 7.

```
TABLE 2
{
  “kind”: “flowchart”,
  “fig_number”: 7,
  “outline_tree”: [
    {
      “id”: “claim-1-1”,
      “parent”: “”,
      “text”: “displaying a user interface including a tree interface”,
      “kind”: “claimSegment”,
      “claimNumber”: 1,
      “block”: 702,
    },{
      “id”: “claim-2-1”,
      “parent”: “”,
      “text”: “receiving an input image associated with the section; and”,
      “kind”: “claimSegment”,
      “claimNumber”: 2,
    },{
      “id”: “claim-2-2”,
      “parent”: “”,
      “text”: “in response to a prompt associated with the input image,
obtaining an image description of the input image in at least two formats.”,
      “kind”: “claimSegment”,
      “claimNumber”: 2,
    },{
      “id”: “claim-1-2”,
      “parent”: “”,
      “text”: “receiving a first input in the user interface that configures a
first node of the first tree data, wherein the first tree data encodes a
writing intent associated with the section prior to invoking a generative
response engine;”,
      “kind”: “claimSegment”,
      “claimNumber”: 1,
      “block”: 704,
    },{
      “id”: “claim-7-0”,
      “parent”: “claim-1-2”,
      “text”: “receiving the first input comprises: displaying claims
associated with the patent application, wherein each claim is displayed
with limitations separated by line breaks; receiving a selection of a
limitation of the claims; and detecting a user input of the selection
into a node of the tree interface.”,
      “kind”: “claimSegment”,
    },{
      “id”: “claim-9-1”,
      “parent”: “claim-1-2”,
      “text”: “detecting the user input of the selection into the parent
node of the tree interface, wherein the user input comprises a drag
of the selection or a drag associated with a node type.”,
      “kind”: “claimSegment”,
      “claimNumber”: 9,
    },{
      “id”: “sog7ua7yi2”,
      “parent”: “”,
      “text”: “Chat Interface and drag the content in the chat interface
into the tree”,
      “kind”: “section”,
    },
    ...
  ],
  “subject”: “flowchart 700”
}
```

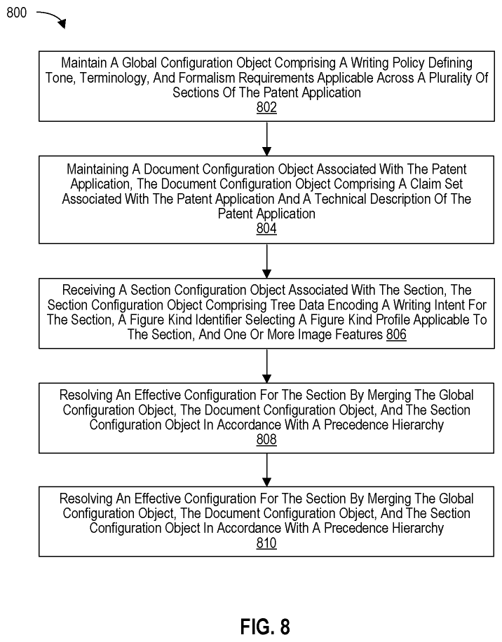

FIG. 8 illustrates an example process 800 for generating patent application using a structured intent patent application drafting system in accordance with some aspects of the disclosure.

At block 802, the computing device may maintain a global configuration object comprising a writing policy defining tone, terminology, and formalism requirements applicable across a plurality of sections of the patent application. In some aspects, the global configuration object may define application-wide parameters including hedging language preferences, reference numeral usage conventions, prohibited terminology, coverage expectations, and output validation rules that apply uniformly to every section of the patent application regardless of figure type or subject matter. The global configuration object may further define a node kind schema comprising a natural language description of each node type supported by the tree data structure, establishing the behavioral contract that governs how the generative response engine interprets each node during generation. In some aspects, the global configuration object may also define a merge policy that specifies how conflicts between configuration levels are resolved, ensuring that the effective configuration produced at a later stage is assembled deterministically from the available configuration sources.

At block 804, the computing device may maintain a document configuration object associated with the patent application, the document configuration object comprising a claim set associated with the patent application and a technical description of the patent application, wherein the document configuration object inherits parameters from the global configuration object and document-level parameters take precedence over global-level parameters upon conflict. In some aspects, the document configuration object may further include a technical problem statement, a technical solution summary, and references to source materials such as disclosure documents, inventor conference transcripts, and supplemental technical notes that provide grounding context for the claim set. The document configuration object may also carry a retrieval configuration that identifies the vector store or other retrieval resource associated with the patent application, enabling the generative response engine to access semantically relevant source content during generation when retrieval-augmented generation is applicable. Because the document configuration object inherits from the global configuration object and its parameters take precedence over global-level parameters upon conflict, the document configuration object may refine or extend application-wide writing policy to accommodate technology-domain-specific conventions, such as the structural conventions applicable to chemical or biological applications, without negating the global constraints that apply uniformly across all applications.

At block 806, the computing device may receive a section configuration object associated with the section, the section configuration object comprising tree data encoding a writing intent for the section, a figure kind identifier selecting a figure kind profile applicable to the section, and one or more image features identifying labeled elements to be described in generated content for the section, wherein section-level parameters of the section configuration object take precedence over the document-level parameters upon conflict. The tree data within the section configuration object comprises a hierarchical arrangement of typed nodes that collectively specify the organizational structure, conceptual scope, claim alignment, and policy constraints applicable to the generation of content for the section, and that writing intent is fully encoded in the tree data before the generation step is invoked. The figure kind identifier selects among a set of figure kind profiles, such as a flowchart profile, a block diagram profile, a sequence diagram profile, or an image profile, each of which provides a section-specific generation framework including an opening sentence template, a post-opening transition rule, and block-level or component-level language conventions applicable to that figure type. The one or more image features enumerate the labeled elements depicted in the figure associated with the section, establishing the authoritative set of elements that the generated content should describe at least once and that the generative response engine may not supplement with additional unlabeled elements. In some aspects, the section configuration object may additionally include primary and alternative image data representations of the figure, enabling the generative response engine to analyze the figure directly when image analysis is applicable to the generation task.

At block 808, the computing device may resolve an effective configuration for the section by merging the global configuration object, the document configuration object, and the section configuration object in accordance with a precedence hierarchy. The merging operation applies the precedence hierarchy such that global-level parameters establish the baseline, document-level parameters refine or override global-level parameters where applicable, and section-level parameters apply the most locally scoped overrides, producing an effective configuration in which all conflicts are resolved before the prompt is assembled. In some aspects, the merge operation may apply different merge strategies depending on the type of parameter being merged, using scalar override for single-valued parameters, deep object merge for nested configuration objects, and set union for array-valued parameters such as lists of prohibited phrases, preferred verbs, or spatial relation terms, so that additive constraints accumulate across configuration levels rather than being replaced. The resolved effective configuration represents the complete, non-conflicting set of generation parameters applicable to the current section and serves as the sole input to the prompt assembly operation at block 810.

At block 810, the computing device may generate the prompt based on the effective configuration, wherein the prompt comprises the tree data serialized in a data interchange format, a natural language description of each node type of a plurality of node types associated with the tree data, at least a portion of the writing policy as resolved by the effective configuration, and at least a portion of the claim set associated with the patent application. The tree data may be serialized into the data interchange format by ordering the nodes according to a depth-first traversal of the tree data prior to serialization, such that ancestor nodes appear before their descendants in the serialized representation and the generative response engine processes inherited context from parent nodes before encountering the child directives that refine it. The natural language description of each node type, drawn from the node kind schema maintained in the global configuration object, is included in the prompt to instruct the generative response engine how to interpret the semantic role of each node encountered during traversal without requiring the model to infer those distinctions from structural position alone. The portion of the claim set included in the prompt provides the generative response engine with the claim limitations associated with the patent application, enabling claim segment nodes in the tree data to be recognized as anchors to specific limitations and enabling the generated content to be aligned with claim scope without verbatim recitation. In some aspects, the prompt may further include the image data representations and image features from the section configuration object, providing the generative response engine with both a visual and a structured representation of the figure associated with the section and establishing the complete set of labeled elements that the generated content is expected to cover.

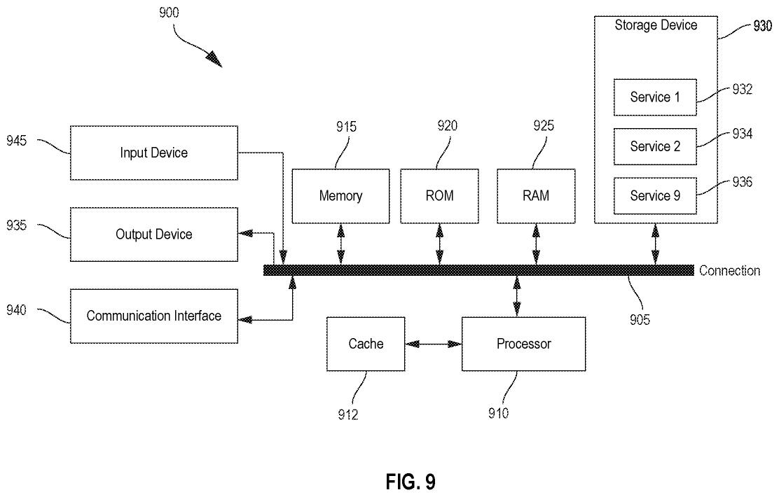

FIG. 9 is a diagram illustrating an example of a system for implementing certain aspects of the present technology. In particular, FIG. 9 illustrates an example of computing system 900, which may be, for example, any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple datacenters, a peer network, etc. In some embodiments, one or more of the described system components represents many such components each performing some or all of the function for which the component is described. In some embodiments, the components may be physical or virtual devices.

An example computing system 900 includes a processor 910 and connection 905 that communicatively couples various system components including system memory 915, such as ROM 920 and RAM 925 to processor 910. Computing system 900 may include a cache 912 of high-speed memory connected directly with, in close proximity to, or integrated as part of processor 910.

The processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communications interface may perform or facilitate receipt and/or transmission of wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 4G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer-readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, an EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASH EPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

In some embodiments, the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. One or more processor(s) may perform the necessary tasks. Examples of form factors include laptops, smartphones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, perform one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference is made to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

Aspects of the disclosure include:
Aspect 1. A method for generating at least a section of a patent application, comprising: displaying a user interface including a tree interface, wherein the tree interface is configured to display first tree data associated with a section of a patent application; receiving a first input in the user interface that configures a first node of the first tree data, wherein the first tree data encodes a writing intent associated with the section prior to invoking a generative response engine; sending a first prompt to the generative response engine, wherein the first prompt includes a writing policy, the first tree data in a data interchange format, and a natural language explanation of each node type associated with the first tree data; and obtaining a response from the generative response engine, the response including first generated content that corresponds to the first tree data and conforms to the writing policy.
Aspect 2. The method of Aspect 1, further comprising: receiving an input image associated with the section; and in response to a prompt associated with the input image, obtaining an image description of the input image in at least two formats, wherein a first format is structured and a second format is unstructured, wherein the first prompt includes the image description.
Aspect 3. The method of any of Aspects 1 to 2, wherein the response is formatted in the data interchange format and includes second tree data.
Aspect 4. The method of any of Aspects 1 to 3, wherein the first prompt further includes a schema defining the node types of the first tree data.
Aspect 5. The method of any of Aspects 1 to 4, further comprising: updating the first tree data to include a patch of nodes in the response; and updating the user interface to display a second tree data based on the response.
Aspect 6. The method of any of Aspects 1 to 5, wherein the response includes a text description generated based on the first tree data and the writing policy.
Aspect 7. The method of any of Aspects 1 to 6, wherein receiving the first input comprises: displaying claims associated with the patent application, wherein each claim is displayed with limitations separated by line breaks; receiving a selection of a limitation of the claims; and detecting a user input of the selection into a node of the tree interface.
Aspect 8. The method of any of Aspects 1 to 7, wherein receiving the user input from the user interface comprises: displaying a chat interface for the generative response engine, the chat interface including at least one response associated with a third prompt to the generative response engine; receiving a selection associated with the at least one response; and detecting user input of the selection into a parent node of the tree interface.
Aspect 9. The method of Aspect 8, wherein receiving the user input from the user interface comprises: detecting the user input of the selection into the parent node of the tree interface, wherein the user input comprises a drag of the selection or a drag associated with a node type.
Aspect 10. The method of any of Aspects 1 to 9, wherein generating the first prompt comprises ordering the nodes of the first tree data based on a depth-first traversal of the first tree data prior to serialization into the data interchange format.
Aspect 11. The method of any of Aspects 1 to 10, further comprising: generating the patent application as an electronic document including at least the text content.

Aspect 12. The method of any of Aspects 1 to 11, wherein generating the prompt comprises sorting nodes of the first tree data based on an order of parent nodes.

Aspect 13. The method of any of Aspects 1 to 12, wherein the writing policy is derived from a hierarchical configuration comprising a global configuration object defining application-wide parameters and a document configuration object defining parameters specific to the patent application, wherein the document configuration object inherits from the global configuration object and section-level parameters take precedence over document-level parameters upon conflict.

Aspect 14. The method of any of Aspects 1 to 13, further comprising: detecting insertion of an image to be inline with text of the section of the patent application; transmitting a prompt to the generative response engine comprising the image and a portion of the writing policy; and obtaining, from the generative response engine, an initial set of nodes organized as initial tree data corresponding to the section, wherein the initial set of nodes is based on components and relationships identified in the image.

Aspect 15. The method of any of Aspects 1 to 14, further comprising: storing the first tree data and a portion of the writing policy as a data artifact within a custom XML constituent of an electronic document file, wherein the data artifact persists the writing intent locally within the electronic document file without requiring an external data store.

Aspect 16. The method of any of Aspects 1 to 15, further comprising: inserting the text description into a document at a location identified by an interpolation tag within the document, wherein the interpolation tag carries an instruction specifying content to be generated at that location.

Aspect 17. A method for generating a prompt for a generative response engine for use in drafting a section of a patent application, comprising: maintaining a global configuration object comprising a writing policy defining tone, terminology, and formalism requirements applicable across a plurality of sections of the patent application; maintaining a document configuration object associated with the patent application, the document configuration object comprising a claim set associated with the patent application and a technical description of the patent application, wherein the document configuration object inherits parameters from the global configuration object and document-level parameters take precedence over global-level parameters upon conflict; receiving a section configuration object associated with the section, the section configuration object comprising tree data encoding a writing intent for the section, a figure kind identifier selecting a figure kind profile applicable to the section, and one or more image features identifying labeled elements to be described in generated content for the section, wherein section-level parameters of the section configuration object take precedence over the document-level parameters upon conflict; resolving an effective configuration for the section by merging the global configuration object, the document configuration object, and the section configuration object in accordance with a precedence hierarchy; and generating the prompt based on the effective configuration, wherein the prompt comprises the tree data serialized in a data interchange format, a natural language description of each node type of a plurality of node types associated with the tree data, at least a portion of the writing policy as resolved by the effective configuration, and at least a portion of the claim set associated with the patent application.

Aspect 18. A computing device for generating at least a section of a patent application, comprising: at least one memory; and at least one processor coupled to the at least one memory and configured to: displaying a user interface including a tree interface, wherein the tree interface is configured to display first tree data associated with a section of a patent application; receiving a first input in the user interface that configures a first node of the first tree data, wherein the first tree data encodes a writing intent associated with the section prior to invoking a generative response engine; sending a first prompt to the generative response engine, wherein the first prompt includes a writing policy, the first tree data in a data interchange format, and a natural language explanation of each node type associated with the first tree data; and obtaining a response from the generative response engine, the response including first generated content that corresponds to the first tree data and conforms to the writing policy.

Aspect 19. The computing device of Aspect 18, wherein the at least one processor is configured to: receiving an input image associated with the section; and in response to a prompt associated with the input image, obtaining an image description of the input image in at least two formats, wherein a first format is structured and a second format is unstructured, wherein the first prompt includes the image description.

Aspect 20. The computing device of any of Aspects 18 to 19, wherein the response is formatted in the data interchange format and includes second tree data.

Aspect 21. The computing device of any of Aspects 18 to 20, wherein the first prompt further includes a schema defining the node types of the first tree data.

Aspect 22. The computing device of any of Aspects 18 to 21, wherein the at least one processor is configured to: update the first tree data to include a patch of nodes in the response; and update the user interface to display a second tree data based on the response.

Aspect 23. The computing device of any of Aspects 18 to 22, wherein the response includes a text description generated based on the first tree data and the writing policy.

Aspect 24. The computing device of any of Aspects 18 to 23, wherein receiving the first input comprises: displaying claims associated with the patent application, wherein each claim is displayed with limitations separated by line breaks; receiving a selection of a limitation of the claims; and detecting a user input of the selection into a node of the tree interface.

Aspect 25. The computing device of any of Aspects 18 to 24, wherein the at least one processor is configured to: display a chat interface for the generative response engine, the chat interface including at least one response associated with a third prompt to the generative response engine; receive a selection associated with the at least one response; and detect user input of the selection into a parent node of the tree interface.

Aspect 26. The computing device of Aspect 25, wherein the at least one processor is configured to: detect the user input of the selection into the parent node of the tree interface, wherein the user input comprises a drag of the selection or a drag associated with a node type.

Aspect 27. The computing device of any of Aspects 18 to 26, wherein generating the first prompt comprises ordering the nodes of the first tree data based on a depth-first traversal of the first tree data prior to serialization into the data interchange format.

Aspect 28. The computing device of any of Aspects 18 to 27, wherein the at least one processor is configured to: generate the patent application as an electronic document including at least the text content.

Aspect 29. The computing device of any of Aspects 18 to 28, wherein generating the prompt comprises sorting nodes of the first tree data based on an order of parent nodes.

Aspect 30. The computing device of any of Aspects 18 to 29 wherein the writing policy is derived from a hierarchical configuration comprising a global configuration object defining application-wide parameters and a document configuration object defining parameters specific to the patent application, wherein the document configuration object inherits from the global configuration object and section-level parameters take precedence over document-level parameters upon conflict.

Aspect 31. The computing device of any of Aspects 18 to 30, wherein the at least one processor is configured to: detect insertion of an image to be inline with text of the section of the patent application; transmit a prompt to the generative response engine comprising the image and a portion of the writing policy; and obtain, from the generative response engine, an initial set of nodes organized as initial tree data corresponding to the section, wherein the initial set of nodes is based on components and relationships identified in the image.

Aspect 32. The computing device of any of Aspects 18 to 31, wherein the at least one processor is configured to: store the first tree data and a portion of the writing policy as a data artifact within a custom XML constituent of an electronic document file, wherein the data artifact persists the writing intent locally within the electronic document file without requiring an external data store.

Aspect 33. The computing device of any of Aspects 18 to 32, wherein the at least one processor is configured to: insert the text description into a document at a location identified by an interpolation tag within the document, wherein the interpolation tag carries an instruction specifying content to be generated at that location.

Aspect 34. A computing device for generating at least a section of a patent application, comprising: at least one memory; and at least one processor coupled to the at least one memory and configured to: maintaining a global configuration object comprising a writing policy defining tone, terminology, and formalism requirements applicable across a plurality of sections of the patent application; maintaining a document configuration object associated with the patent application, the document configuration object comprising a claim set associated with the patent application and a technical description of the patent application, wherein the document configuration object inherits parameters from the global configuration object and document-level parameters take precedence over global-level parameters upon conflict; receiving a section configuration object associated with the section, the section configuration object comprising tree data encoding a writing intent for the section, a figure kind identifier selecting a figure kind profile applicable to the section, and one or more image features identifying labeled elements to be described in generated content for the section, wherein section-level parameters of the section configuration object take precedence over the document-level parameters upon conflict; resolving an effective configuration for the section by merging the global configuration object, the document configuration object, and the section configuration object in accordance with a precedence hierarchy; and generating the prompt based on the effective configuration, wherein the prompt comprises the tree data serialized in a data interchange format, a natural language description of each node type of a plurality of node types associated with the tree data, at least a portion of the writing policy as resolved by the effective configuration, and at least a portion of the claim set associated with the patent application.

What is claimed is:

1. A method for generating at least a section of a patent application, comprising:
displaying a user interface including a tree interface, wherein the tree interface is configured to display first tree data associated with a section of a patent application;
receiving a first input in the user interface that configures a first node of the first tree data, wherein the first tree data encodes a writing intent associated with the section prior to invoking a generative response engine;
sending a first prompt to the generative response engine, wherein the first prompt includes a writing policy, the first tree data in a data interchange format, and a natural language explanation of each node type associated with the first tree data; and
obtaining a response from the generative response engine, the response including first generated content that corresponds to the first tree data and conforms to the writing policy.

2. The method of claim 1, further comprising:
receiving an input image associated with the section; and
in response to a prompt associated with the input image, obtaining an image description of the input image in at least two formats, wherein a first format is structured and a second format is unstructured, wherein the first prompt includes the image description.

3. The method of claim 1, wherein the response is formatted in the data interchange format and includes second tree data.

4. The method of claim 1, wherein the first prompt further includes a schema defining the node types of the first tree data.

5. The method of claim 1, further comprising:
updating the first tree data to include a patch of nodes in the response; and
updating the user interface to display a second tree data based on the response.

6. The method of claim 1, wherein the response includes a text description generated based on the first tree data and the writing policy.

7. The method of claim 1, wherein receiving the first input comprises: displaying claims associated with the patent application, wherein each claim is displayed with limitations separated by line breaks; receiving a selection of a limitation of the claims; and
detecting a user input of the selection into a node of the tree interface.

8. The method of claim 1, wherein receiving the user input from the user interface comprises:
displaying a chat interface for the generative response engine, the chat interface including at least one response associated with a third prompt to the generative response engine;
receiving a selection associated with the at least one response; and
detecting user input of the selection into a parent node of the tree interface.

9. The method of claim 8, wherein receiving the user input from the user interface comprises:
detecting the user input of the selection into the parent node of the tree interface, wherein the user input comprises a drag of the selection or a drag associated with a node type.

10. The method of claim 1, wherein generating the first prompt comprises ordering the nodes of the first tree data based on a depth-first traversal of the first tree data prior to serialization into the data interchange format.

11. The method of claim 1, further comprising:
generating the patent application as an electronic document including at least the text content.

12. The method of claim 1, wherein generating the prompt comprises sorting nodes of the first tree data based on an order of parent nodes.

13. The method of claim 1, wherein the writing policy is derived from a hierarchical configuration comprising a global configuration object defining application-wide parameters and a document configuration object defining parameters specific to the patent application, wherein the document configuration object inherits from the global configuration object and section-level parameters take precedence over document-level parameters upon conflict.

14. The method of claim 1, further comprising:
detecting insertion of an image to be inline with text of the section of the patent application;
transmitting a prompt to the generative response engine comprising the image and a portion of the writing policy; and
obtaining, from the generative response engine, an initial set of nodes organized as initial tree data corresponding to the section, wherein the initial set of nodes is based on components and relationships identified in the image.

15. The method of claim 1, further comprising:
storing the first tree data and a portion of the writing policy as a data artifact within a custom XML constituent of an electronic document file, wherein the data artifact persists the writing intent locally within the electronic document file without requiring an external data store.

16. The method of claim 1, further comprising: inserting the text description into a document at a location identified by an interpolation tag within the document, wherein the interpolation tag carries an instruction specifying content to be generated at that location.

17. A method for generating a prompt for a generative response engine for use in drafting a section of a patent application, comprising:
maintaining a global configuration object comprising a writing policy defining tone, terminology, and formalism requirements applicable across a plurality of sections of the patent application;
maintaining a document configuration object associated with the patent application, the document configuration object comprising a claim set associated with the patent application and a technical description of the patent application, wherein the document configuration object inherits parameters from the global configuration object and document-level parameters take precedence over global-level parameters upon conflict;
receiving a section configuration object associated with the section, the section configuration object comprising tree data encoding a writing intent for the section, a figure kind identifier selecting a figure kind profile applicable to the section, and one or more image features identifying labeled elements to be described in generated content for the section, wherein section-level parameters of the section configuration object take precedence over the document-level parameters upon conflict;
resolving an effective configuration for the section by merging the global configuration object, the document configuration object, and the section configuration object in accordance with a precedence hierarchy; and
generating the prompt based on the effective configuration, wherein the prompt comprises the tree data serialized in a data interchange format, a natural language description of each node type of a plurality of node types associated with the tree data, at least a portion of the writing policy as resolved by the effective configuration, and at least a portion of the claim set associated with the patent application.

18. A computing device for generating at least a section of a patent application, comprising:
at least one memory; and
at least one processor coupled to the at least one memory and configured to:
displaying a user interface including a tree interface, wherein the tree interface is configured to display first tree data associated with a section of a patent application;
receiving a first input in the user interface that configures a first node of the first tree data, wherein the first tree data encodes a writing intent associated with the section prior to invoking a generative response engine;
sending a first prompt to the generative response engine, wherein the first prompt includes a writing policy, the first tree data in a data interchange format, and a natural language explanation of each node type associated with the first tree data; and
obtaining a response from the generative response engine, the response including first generated content that corresponds to the first tree data and conforms to the writing policy.

19. The computing device of claim 18, wherein the at least one processor is configured to:
receiving an input image associated with the section; and
in response to a prompt associated with the input image, obtaining an image description of the input image in at least two formats, wherein a first format is structured and a second format is unstructured, wherein the first prompt includes the image description.

20. The computing device of claim 18, wherein the response is formatted in the data interchange format and includes second tree data.
